(19) United States
(12) Patent Application Publication
(10) Pub. No.: US 2007/0197203 A1
(43) Pub. Date: Aug. 23, 2007

(54) METHOD FOR REMOTELY CONTROLLING A MOBILE COMMUNICATION DEVICE

(76) Inventor: Min-Tza Hu, Ping-Tung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/672,049

(22) Filed: Feb. 7, 2007

(30) Foreign Application Priority Data
Feb. 23, 2006 (TW) 095106138

(51) Int. Cl. H04M 3/00

(52) U.S. Cl. 455/419

(57) ABSTRACT

A method of controlling a mobile communication device includes a first mobile communication device transmitting address data of the first mobile communication device to a second mobile communication device; the second mobile communication device transmitting a system specification of the second mobile communication device to the first mobile communication device according to the address data; the second mobile communication device transmitting a system status of the second mobile communication device to the first mobile communication device; the first mobile communication device transmitting a command to the second mobile communication device; and the second mobile communication device executing the command.

### BACKGROUND OF THE INVENTION

1. Field of the Invention

The present invention provides a method for remotely controlling a mobile communication device, and more particularly, a method for controlling a mobile communication device from a remote end.

2. Description of the Prior Art

As the related technology progresses, functions of mobile communication devices are getting stronger. Nowadays, mobile communication devices are not only used to make a phone call but also to photograph, to video-record, to play music, to play video, and even to connect to the internet and to execute several kinds of application programs. Although mobile communication devices provide versatile functions that increase users' convenience, they also become more complicated to use, and moreover, mobile communication devices will probably not be able to resume their default states because of improper use.

When a user does not know how to use some functions of the mobile communication device, or the user manipulates the mobile communication device improperly and causes the device to be unable to resume the default state, the only thing the user can do is bring the mobile communication device to specific service locations or call the customer service line for help. However, the user has to go to the service location himself, and it is quite inconvenient and time-consuming. If the user calls the customer service line for help, though the customer service representative can provide solutions right away, the communication between the user and the customer service representative is not clear if the problem is too complicated.

### SUMMARY OF THE INVENTION

It is therefore an objective of the claimed invention to provide a method for remotely controlling mobile communication devices to solve the problems described above.

A method for remotely controlling mobile communication devices in a mobile communication system, comprises the following steps:(a) a first mobile communication device transmitting address data of the first mobile communication device to a second mobile communication device;(b) the second mobile communication device transmitting system specification data of the second mobile communication device to the first mobile communication device in response to receiving the address data transmitted from the first mobile communication device;(c) the second mobile communication device transmitting system status data of the second mobile communication device to the first mobile communication device;(d) the first mobile communication device transmitting a command to the second mobile communication device; and (e) the second mobile communication device executing the command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the process of remote control to the mobile phone of the present invention.

FIG. 2 is a diagram illustrating using the present invention to transmit data packets.

FIG. 3 is a flowchart of the method of the present invention for remote control to the mobile phone.

### DETAILED DESCRIPTION

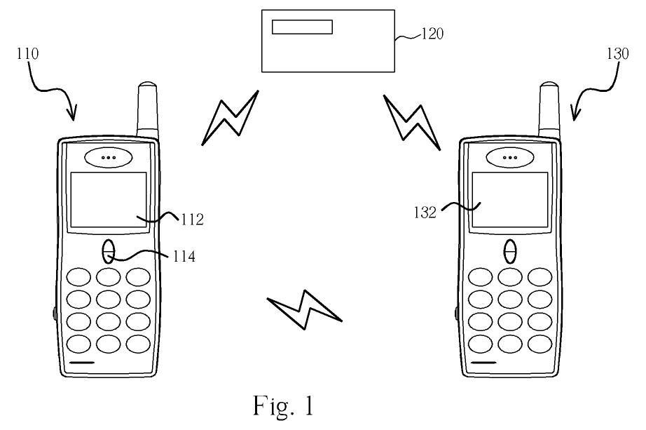

Please refer to FIG. 1. The embodiment in FIG. 1 takes mobile phone for example, however, the mobile communication device of the present invention also can be mobile computers with communication functions or PDAs. FIG. 1 is a diagram illustrating the present invention remotely controlling mobile phones. In the present invention, when a user's mobile phone 110 has a problem, the user can first login to in the service system and bring up the service demand. There are many methods to login in the service system. For example, the user's mobile phone 110 can be used to access the internet for logging into the service website 120. First, the user enters a username and password into the service website 120 through the user's mobile phone 110. When the username and password matches a predetermined username and password saved in the service website 120, the service website 120 sends a message to the mobile phone 130 of the customer service for allowing the customer service representative to know that user needs help. When the user's mobile phone 110 transmits data to the service website 120, the service website 120 can know the address of the user's mobile phone 110 right away, for example, the internet protocol address. Thus, when the customer service representative finds that a user calls for help, the customer service representative transmits data with the address of the service end of the mobile phone 130 to the user's mobile phone in response to the address of the user's mobile phone 110. The address of the service end of the mobile phone 130 is also an internet protocol address. In this way, the user's mobile phone 110 and the service end of the mobile phone 130 can transmit data to each other according to both addresses. And then the user's mobile phone 110 transmit data containing its system specification, for example, the screen size and audio format of the user's mobile phone, to the service end of the mobile phone 130 so that the service end of the mobile phone 130 can communicate with the user's mobile phone according to system specification of the user's mobile phone 110. After knowing the system specification of the user's mobile phone 110, the service end of the mobile phone 130 transmits data for starting to remotely control the user's mobile phone 110 for activating remote control. After activating remote control, the user can not use the buttons to control the user's mobile phone 110, and the user's mobile phone will transmit data with the system status data of the user's mobile phone 110 in a specific period, for example, the data with the displayed image of the screen 112 of the user's mobile phone 110 or the current used program status, to the mobile phone 130 of the service end. The service end of the mobile phone 130 displays the image of the screen 112 of the user's mobile phone 110 at the screen 132 of the mobile phone 130 of the service end. Thus, the customer service representative can know immediately the problem of the user's mobile phone 110. Additionally, the system can also be set if the system status of the user's mobile phone 110 changes in the specific period, and the user's mobile phone 110 sends right away the changed system status to the mobile phone 130 of the service end.

After the customer service representative judges how to solve the problem of the user's mobile phone 110, the customer service representative can use the service end of the mobile phone 130 to transmit data of a command to the user's mobile phone 110 so that the user's mobile phone 110 can execute according to the command. For example, if the customer service representative wants to trigger a downward key 114 of the user's mobile phone 110, the customer service representative uses the service end of the mobile phone 130 to transmit a command to trigger the downward key 114 to the user's mobile phone 110. After the user's mobile phone 110 receives the command of triggering the downward key 114, the downward key 114 is triggered at user's end. Because the user's mobile phone 110 transmits data with the displayed image of the screen 112 of the user's mobile phone 110 in a specific period to the mobile phone 130 of the service end, the customer service representative can periodically update how the user's mobile phone 110 is executing according to the command and judges what further commands are needed. Additionally, when the customer service representative uses the service end of the mobile phone 130 to transmit data of a specific command to the user's mobile phone 110, according to the system specification of the user's mobile phone 110, the customer service representative also records a voice message to explain the meaning of executing the command, and uses the service end of the mobile phone 130 to transmit data with the voice message to the user's mobile phone 110. When the mobile phone 110 plays the voice message, the user can understand the purpose of the customer service representative executing the command. If the user has any question, he can use the user's mobile phone 110 to record another voice message and transmit data with the voice message to the mobile phone 130 of the service end, sending questions to the customer service representative. In this way, the user and the customer service representative can communicate with each other more clearly. After solving the problem, the customer service representative uses the service end of the mobile phone 130 to transmit data to end the remote control of the user's mobile phone 110. Meanwhile, the user can choose whether to end the remote control or not. If so, the remote control is ended. If not, the remote control still proceeds, and repeats the procedures above.

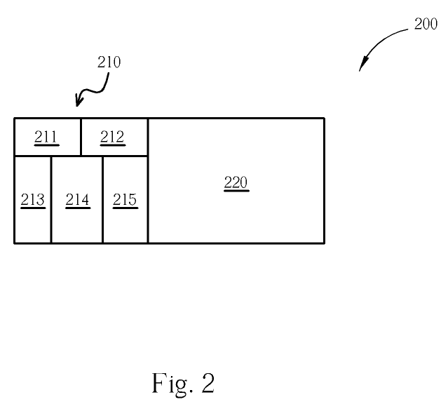

Additionally, in the present embodiment, the user's mobile phone 110 and the service end of the mobile phone 130 transmit data of packet types to each other. Please refer to FIG. 2. FIG. 2 is a diagram illustrating the present invention transmitting a data packet 200. The data packet 200 includes a packet header 210 and a packet data 220. There is a plurality of areas in the packet header 210, for example, a source address 211 for recording the address of the transmitting mobile phone, a destination address 212 for recording the address of the receiving mobile phone, data type area 213 for indicating the type of data packets, data length area 214 for indicating the length of data packets, and an error check area 215 for recording error check codes. And the data packet 220 is used to record the data which the user's mobile phone 110 or service end of the mobile phone 130 want to transmit, for example, the voice message or the command. The command formats of the data packets between the user's mobile phone 110 and the service end of the mobile phone 130 will be unified, and reactions corresponding to different commands are established in the both mobile phones for smoothly communicating with each other. For instance, when the service end of the mobile phone 130 transmits the packet for starting remote control to the user's mobile phone 110, the value of the data type area 213 is “0”, representing that this packet is used to activate remote control; when the service end of the mobile phone 130 transmits a packet of voice message to the user's mobile phone 110, the data type area 213 is “1”, representing that the packet includes the voice message, and the packet data 220 stores the voice message, and so on. The packet format described above is one of the packet formats of the embodiment of the present invention, and also other types of packet formats can be used in the present invention.

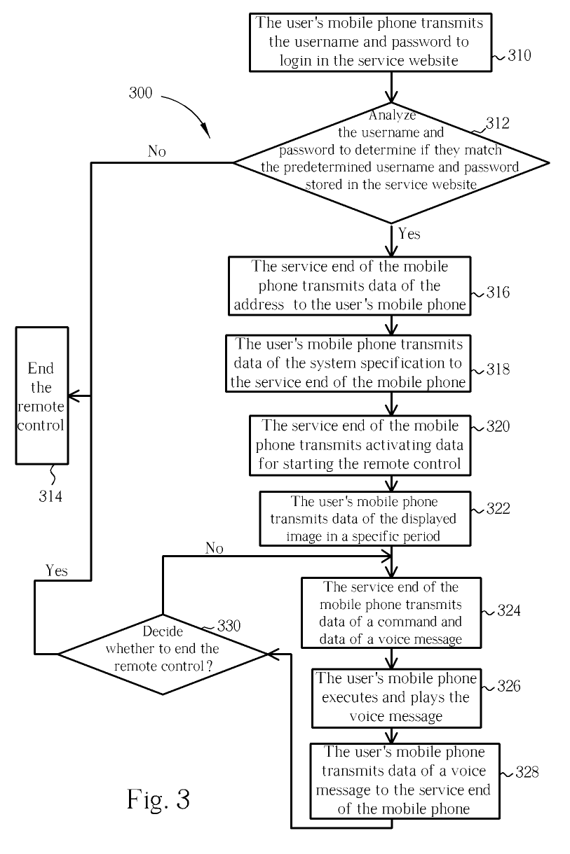

To more particularly illustrate the method of the present invention for remotely controlling mobile phones, FIG. 3 provides a flowchart 300 of the method of the present invention. Please refer to FIG. 3, and together with FIG. 1. The flowchart 300 of FIG. 3 includes the following steps:

Step 310: the user's mobile phone 110 transmits the username and password to login in the service website 120;

Step 312: verify the username and password to determine if they match the predetermined username and password stored in the service website 120, if so, continue step 316; if not, continue step 314;

Step 314: end the remote control;

Step 316: the service end of the mobile phone 130 transmits data of the address of the service end of the mobile phone 130 to the user's mobile phone 110 according to the service website 120;

Step 318: the user's mobile phone 110 transmits data of the system specification to the service end of the mobile phone 130;

Step 320: the service end of the mobile phone 130 transmits activating data for starting the remote control of the user's mobile phone 110;

Step 322: the user's mobile phone 110 transmits data of the displayed image of the screen 112 of the user's mobile phone 110 to the service end of the mobile phone 130 in a specific period;

Step 324: the service end of the mobile phone 130 transmits data of a command and data of a voice message to the user's mobile phone 110;

Step 326: according to the command, the user's mobile phone 110 executes and plays the voice message;

Step 328: the user's mobile phone 110 transmits data of a voice message to the service end of the mobile phone 130;

Step 330: decide whether to end the remote control or not, if so, continue step 314; if not, continue step 324.

Basically, to achieve the same result, the steps of the flowchart 300 need not be in the exact order shown and need not be contiguous, that is, other steps can be intermediate. Additionally, the user's mobile phone 110 and the service end of the mobile phone 130 do not have to be the same type of mobile phone. The communication between the user's mobile phone 110 and the service end of the mobile phone 130 is achieved by both of the user's mobile phone 110 and the service end of the mobile phone 130 having the same communication protocol executing the method of the present invention. Although mobile phones of different types have different buttons of different triggers, if the user's mobile phone 110 and the service end of the mobile phone 130 have the same lookup table of button-triggers, the user's mobile phone 110 and the service end of the mobile phone 130 can trigger the corresponding button according to the lookup table. The method of the present invention can be achieved by means of software, software with firmware, or hardware.

Compared with the prior art, the present invention provides a method for remotely controlling mobile phones. When problems arise during operation of a user's mobile phone, the user does not have to go to the service location himself for help from the customer service representative. The user only has to access the internet and acquires the customer service representative's help right away. Additionally, the user and the customer service representative can communicate more clearly by using images in addition to voice communication.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of remotely controlling mobile communication devices in a mobile communication system, the method comprising the following steps:
(a) a first mobile communication device transmitting address data of the first mobile communication device to a second mobile communication device;
(b) the second mobile communication device transmitting system specification data and system status data of the second mobile communication device to the first mobile communication device in response to receiving the address data;
(c) the first mobile communication device transmitting a command to the second mobile communication device according to the system specification data and the system status data of the second mobile communication device; and
(d) the second mobile communication device executing the command for updating the system status data of the second communication device.

2. The method of claim 1, further comprising the second mobile communication device transmitting authentication data to a system service end, wherein step (a) further comprises:
the system service end notifies the first mobile communication device to transmit the address data to the second mobile communication device when the authentication data matches a predetermined authentication data.

3. The method of claim 1, further comprising the first mobile communication device transmitting voice data to the second mobile communication device.

4. The method of claim 3, further comprising the second mobile communication device playing the voice data.

5. The method of claim 1, further comprising the first mobile communication device displaying the system status of the second mobile communication device in the screen of the first mobile communication device according to the system specification of the second mobile communication device.

6. The method of claim 5, wherein the second mobile communication device executes the command from the first mobile communication device for updating the system status of the second mobile communication device further comprises transmitting the updated system status to the first mobile communication device.

7. The method of claim 1, wherein the system specification of the second mobile communication device comprises the screen size and the audio format of the second mobile communication device.

8. The method of claim 1, wherein the address of the first mobile communication device is an internet-protocol (IP) address.

9. The method of claim 1, wherein the system status of the second mobile communication device comprises the screen image of the second mobile communication device.

10. The method of claim 1, further comprising the first mobile communication device transmitting data indicating starting to remote control to the second mobile communication device for starting remote control.

11. The method of claim 1, further comprising the first mobile communication device transmitting data indicating ending remote control to the second mobile communication device for ending remote control.

12. The method of claim 1, further comprising the second mobile communication device transmitting voice data to the first mobile communication device.

13. The method of claim 12, further comprising the first mobile communication device playing the voice data.

14. The method of claim 1, wherein step (c) further comprises the second mobile communication device transmitting a system status data of the second mobile communication device to the first mobile communication device every specific period of time.

15. The method of claim 1, wherein step (c) further comprises the second mobile communication device transmitting the changed system status data to the first mobile communication device after changing the system status of the second mobile communication device.
